(19) United States
(12) Patent Application Publication
(10) Pub. No.: US 2026/0358744 A1
(43) Pub. Date: Nov. 12, 2026

(54) IMAGE FORMING APPARATUS INCLUDING POST-PROCESSING APPARATUS

(71) Applicant: KYOCERA Document Solutions Inc., Osaka (JP)

(72) Inventor: Ryo AMAI, Osaka (JP)

(73) Assignee: KYOCERA Document Solutions Inc., Osaka (JP)

(21) Appl. No.: 19/665,408

(22) Filed: May 1, 2026

(30) Foreign Application Priority Data
May 9, 2025 (JP) 2025-079057

(51) Int. Cl. G03G 15/00

(52) U.S. Cl. CPC G03G 15/6573; G03G 15/6544; G03G 15/6552; G03G 2215/00599; G03G 2215/00721; G03G 2215/00827

(57) ABSTRACT

When a length in a sheet carrying direction of a sheet is larger than a predetermined length, a control device causes an intermediate roller to rotate at a first rotation speed and separates a first discharge roller and a second discharge roller from each other using a drive device in a period in which a body-side discharge roller is carrying the sheet. The control device calculates a residual carrying time from a detection time point at which a detection device detects a sheet leading end of a sheet to a time point at which the body-side discharge roller ends carrying of the sheet, brings the first discharge roller and the second discharge roller into contact using the drive device when the residual carrying time elapses, and causes the intermediate roller and a post-processing-side discharge roller pair to rotate at a second rotation speed higher than the first rotation speed.

### INCORPORATION BY REFERENCE

This application claims priority to Japanese Patent Application No. 2025-079057 filed on May 9, 2025, the entire contents of which are incorporated by reference herein.

### BACKGROUND

The present disclosure relates to an image forming apparatus including a post-processing apparatus.

A post-processing apparatus that performs post-processing on a printed sheet is installed in an image forming apparatus. In a general post-processing apparatus, a subsequently discharged sheet is discharged without interference even when an end of a previously discharged sheet is warped.

In a general image forming apparatus, a sheet winding apparatus is disposed in the post-processing apparatus, and a long recording sheet can be wound as a roll and discharged in a state in which an arbitrary surface of the recording sheet faces upward.

### SUMMARY

An aspect of the present disclosure proposes an improvement of the aforementioned technique.

An image forming apparatus according to the present disclosure includes an apparatus body and a post-processing apparatus. The apparatus body includes an image forming device configured to form an image on a sheet in accordance with a print job. The post-processing apparatus includes a post-processing device attached to the apparatus body and configured to perform post-processing on the sheet in accordance with the print job. The apparatus body further includes a body-side discharge roller. The body-side discharge roller carries the sheet on which an image has been formed by the image forming device from an apparatus-side discharge port to the post-processing apparatus. The post-processing apparatus further includes a carrying passage, an intermediate roller, a post-processing-side discharge roller pair, a detection device, a drive device, and a control unit. The carrying passage carries a sheet from an input port receiving a sheet carried by the body-side discharge roller to a discharge port. The intermediate roller rotates at a first rotation speed which is the same rotation speed as the body-side discharge roller or a second rotation speed higher than the first rotation speed and carries a sheet to the post-processing device or the discharge port. The post-processing-side discharge roller pair includes a first discharge roller and a second discharge roller, is disposed upstream from the discharge port in a sheet carrying direction and downstream from the intermediate roller, and rotates at the second rotation speed to discharge a sheet carried by the intermediate roller to the discharge port. The detection device detects that a sheet leading end in the sheet carrying direction of the sheet has reached the post-processing-side discharge roller pair. The drive device moves the first discharge roller and the second discharge roller to a contact position or a separation position. The control unit includes a processor and serves as a control device by causing the processor to execute a control program. The control device performs drive control of the intermediate roller, the post-processing-side discharge roller pair, and the drive device. The control device causes the intermediate roller to rotate at the first rotation speed and separates the first discharge roller and the second discharge roller from each other using the drive device in a period in which the body-side discharge roller is carrying a sheet when a length in the sheet carrying direction of the sheet is larger than a predetermined length. The control device calculates a residual carrying time which is a time from a detection time point at which the detection device detects a sheet leading end of a sheet to a time point at which the body-side discharge roller ends carrying of the sheet, brings the first discharge roller and the second discharge roller into contact using the drive device when the residual carrying time elapses, and causes the intermediate roller and the post-processing-side discharge roller pair to rotate at the second rotation speed.

### BRIEF DESCRIPTION OF THE DRAWINGS

FIG. 1 is a sectional front view illustrating an image forming apparatus.

FIG. 2 is a diagram illustrating carrying of a sheet in a post-processing apparatus.

FIG. 3 is a diagram illustrating carrying of a sheet in the post-processing apparatus.

FIG. 4 is a diagram illustrating carrying of a sheet in the post-processing apparatus.

FIG. 5 is a diagram illustrating carrying of a sheet in the post-processing apparatus.

FIG. 6 is a diagram illustrating carrying of a sheet in the post-processing apparatus.

FIG. 7 is a diagram illustrating carrying of a sheet in the post-processing apparatus.

FIG. 8 is a diagram illustrating carrying of a sheet in the post-processing apparatus.

FIG. 9 is a flowchart illustrating a sheet carrying flow in the post-processing apparatus.

### DETAILED DESCRIPTION

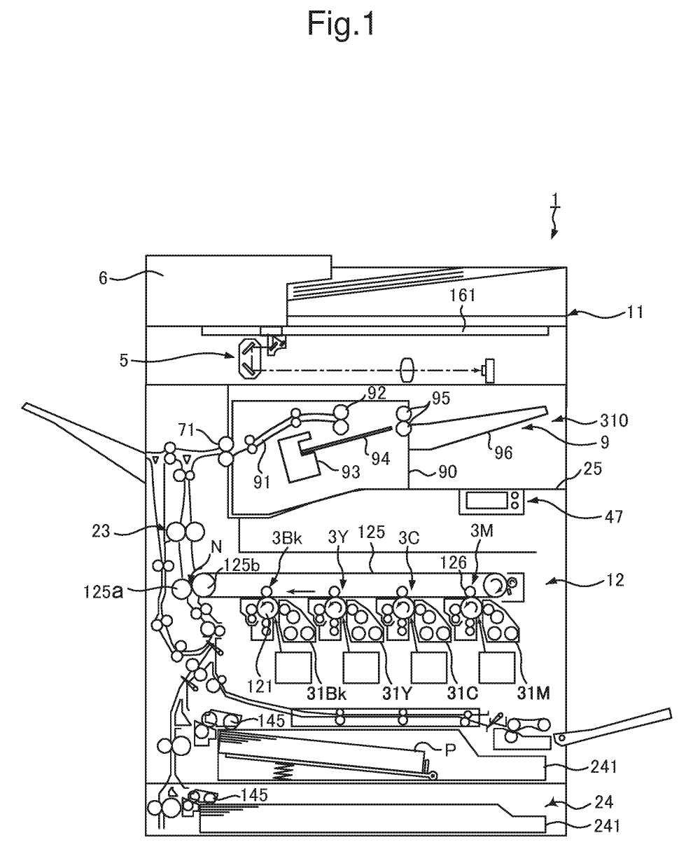

Hereinafter, an image forming apparatus according to an embodiment of the present disclosure will be described with reference to the accompanying drawings. FIG. 1 is a sectional front view illustrating an image forming apparatus 100 according to an embodiment. The image forming apparatus 100 according to the present embodiment is, for example, a multifunction machine that prints an image on a sheet such as a copying machine and a printer and has a plurality of functions such as a copying function, a printer function, and a facsimile function. The image forming apparatus 100 may have the copying function, the printer function, or the facsimile function alone. The image forming apparatus 100 includes an apparatus body 11 and a post-processing apparatus 9.

In the present embodiment, an image forming apparatus of an electrophotographic system in which printing is performed using a toner will be exemplified, but an inkjet printer or the like may be employed. In the present embodiment, the image forming apparatus 100 will be described as a color image forming apparatus, but may be a monochromatic image forming apparatus.

The image forming apparatus 100 illustrated in FIG. 1 includes an input receiving device 47, an image forming device 12, a fixing device 23, a sheet feeding device 24, an original feeding device 6, and an image reading device 5 which are provided in the apparatus body 11.

When the image forming apparatus 100 performs an original reading operation, an image of an original fed by the original feeding device 6 or an original placed on an original placement glass 161 is optically read by the image reading device 5, and image data is generated. The image data generated by the image reading device 5 is stored in a built-in HDD, a network-connected computer, or the like.

When the image forming apparatus 100 performs an image forming operation, the image forming device 12 forms a toner image on a sheet P which is a recording medium fed from the sheet feeding device 24 on the basis of the image data generated through the original reading operation. When color printing is performed, a magenta image forming unit 3M, a cyan image forming unit 3C, a yellow image forming unit 3Y, and a black image forming unit 3Bk of the image forming device 12 form toner images on a photosensitive drum 121 through charging, exposure, and developing steps on the basis of images including color components constituting the image data and transfer the toner images to an intermediate transfer belt 125 using a primary transfer roller 126.

The image forming units 3M, 3C, 3Y, and 3Bk include toner cartridges 31M, 31C, 31Y, and 31Bk (hereinafter referred to as “toner cartridges 31” together) of the corresponding colors. The toner cartridges 31 store color toners used by the image forming device 12. The toner cartridges 31 are detachably attached to the image forming units 3M, 3C, 3Y, and 3Bk, and any toner cartridge is replaced with a new toner cartridge by a user when the toner cartridge 31 becomes empty.

The toner images of the colors transferred to the intermediate transfer belt 125 are superimposed on the intermediate transfer belt 125 with transfer timings thereof adjusted to form a color toner image. A secondary transfer roller 125b transfers the color toner image formed on the surface of the intermediate transfer belt 125 to a sheet P carried along a carrying passage (a sheet carrying passage) from the sheet feeding device 24 in a nip part N with a driving roller 125a with the intermediate transfer belt 125 interposed therebetween. Thereafter, the fixing device 23 fixes the toner image on the sheet P onto the sheet P through thermal compression. Thereafter, the sheet P is discharged to a first discharge tray 25 (an inner sheet discharge part) by a body-side discharge roller 71 which is disposed in the vicinity of an apparatus-side discharge port.

The sheet feeding device 24 includes a plurality of sheet feed cassettes 241. The sheet feed cassettes 241 accommodate sheets P to be carried to the image forming device 12. A control device 211 which will be described later rotationally drives a pickup roller 145 of each sheet feed cassette 241 and carries a sheet P accommodated in the sheet feed cassette 241 to the image forming device 12.

An open space 310 is formed on the apparatus body 11. The open space 310 is a space of a substantially rectangular parallelepiped shape which is laterally long and in which, for example, a front surface and a right surface of the apparatus body 11 are open, and the bottom surface of the open space 310 serves as a first discharge tray 25. The first discharge tray 25 is a tray on which a sheet P printed by the image forming device 12 is discharged and stacked.

The post-processing apparatus 9 is an apparatus that performs post-processing such as stapling on a sheet P, is installed in the open space 310 of the apparatus body 11, and is detachable. The post-processing apparatus 9 is electrically connected to the apparatus body 11, is supplied with electric power, and can transmit and receive data or the like to and from the apparatus body 11.

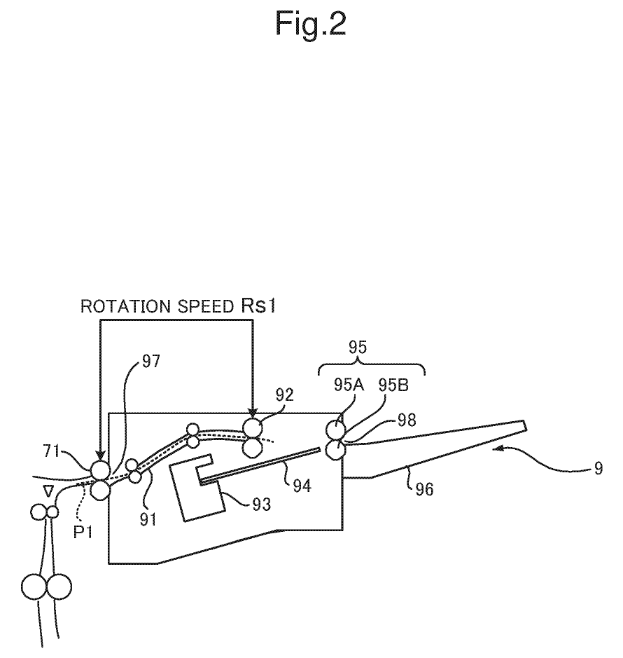

The post-processing apparatus 9 includes a housing 90 of a substantially rectangular parallelepiped shape which is laterally long, an input port 97 (see FIG. 2) is open on the left side of the housing 90, and a discharge port 98 (see FIG. 2) is open on the right side. The input port 97 is provided at a position corresponding to the body-side discharge roller 71 of the apparatus body 11.

The post-processing apparatus 9 includes a carrying passage (a sheet carrying passage) 91, an intermediate roller 92, a post-processing device 93, an intermediate tray 94, and a post-processing-side discharge roller pair 95, and a second discharge tray 96. The carrying passage 91 is a passage for carrying a sheet from the input port 97 to the discharge port 98. The post-processing device 93 is a device that performs a post-processing process such as a stapling process on a sheet.

The intermediate tray 94 is disposed to be tilted obliquely downward from one end (the discharge port 98 side) to the other side. The post-processing-side discharge roller pair 95 is disposed on the one side of the intermediate tray 94. The intermediate tray 94 may constitute a part of the carrying passage 91. The post-processing device 93 performs post-processing on a sheet bundle placed on the intermediate tray 94. By causing the post-processing-side discharge roller pair 95 to rotate with the post-processed sheet bundle interposed therebetween, the sheet bundle is discharged from the discharge port 98 to the second discharge tray 96.

FIGS. 2 - 6 are diagrams illustrating carrying of a sheet in the post-processing apparatus 9. First, FIG. 2 will be described. A sheet P1 is a sheet of which a length in a sheet carrying direction is equal to or less than a predetermined length. The predetermined length is, for example, a length of the carrying passage 91 from the body-side discharge roller 71 to the post-processing-side discharge roller pair 95. The predetermined length is measured at the time of apparatus design and is stored in advance by a control device 811 of the post-processing apparatus 9 which will be described later.

Since the length in the sheet carrying direction of the sheet P1 is equal to or less than the predetermined length, the sheet P1 does not reach the post-processing-side discharge roller pair 95 while the body-side discharge roller 71 is carrying the sheet P1. While the body-side discharge roller 71 is carrying the sheet P1, the body-side discharge roller 71 and the intermediate roller 92 rotate at a rotation speed Rs1 which is a first rotation speed.

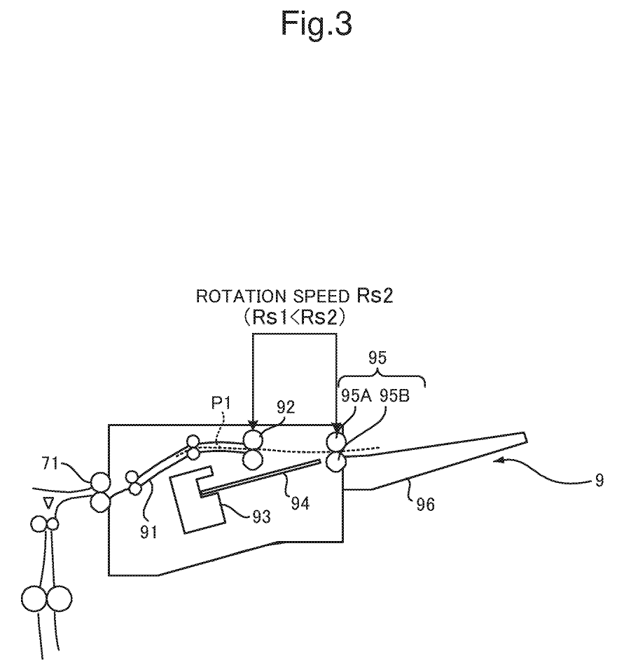

FIG. 3 is a diagram illustrating a state after the body-side discharge roller 71 has ended carrying of the sheet P1. When the body-side discharge roller 71 ends carrying of the sheet P1, the intermediate roller 92 rotates by changing its rotation speed to a rotation speed Rs2 which is a second rotation speed higher than the rotation speed Rs1 of the body-side discharge roller 71. The post-processing-side discharge roller pair 95 is a roller pair that rotates at only the rotation speed Rs2. That is, the intermediate roller 92 and the post-processing-side discharge roller pair 95 rotate at the rotation speed Rs2 to discharge the sheet P1 from the discharge port 98.

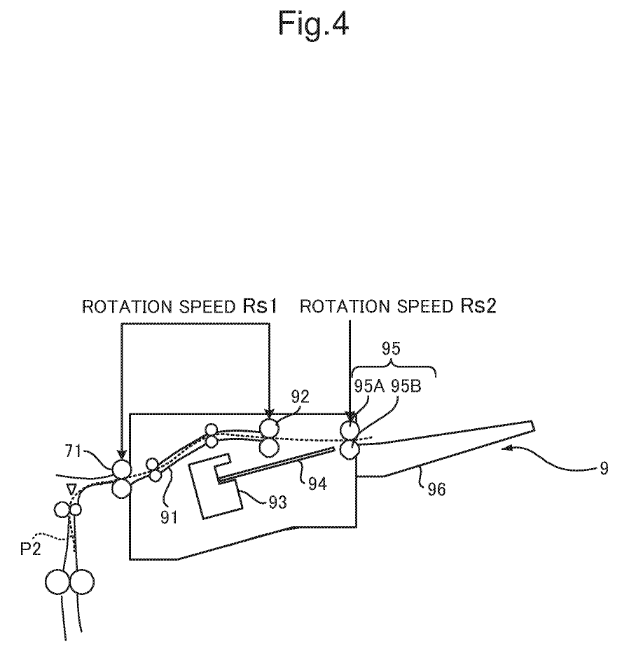

FIG. 4 is a diagram illustrating carrying a sheet P2 of which a length in the sheet carrying direction is larger than the predetermined length. When the length in the sheet carrying direction is larger than the predetermined length, the leading end of the sheet P2 reaches the post-processing-side discharge roller pair 95 while the body-side discharge roller 71 is carrying the sheet P2. That is, the sheet P2 is suspended on three rollers of the body-side discharge roller 71, the intermediate roller 92 and the post-processing-side discharge roller pair 95.

The intermediate roller 92 can rotate at the same rotation speed Rs1 as the body-side discharge roller 71, and the post-processing-side discharge roller pair 95 rotates at only the rotation speed Rs2. That is, the sheet P2 is carried by a plurality of rollers having different rotation speeds, pulling or the like of the sheet P2 between rollers occurs to cause a sheet jam, and a situation in which the sheet P2 is not correctly discharged occurs.

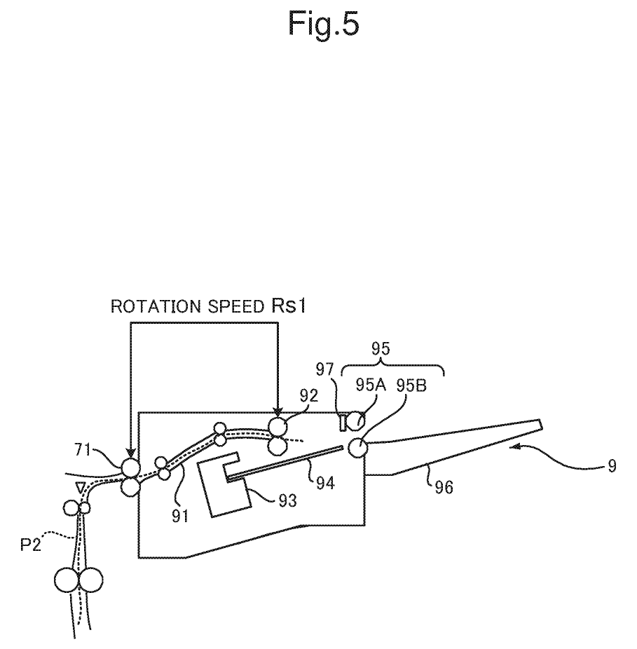

Therefore, as illustrated in FIG. 5, when the sheet P2 longer than the predetermined length is carried to the post-processing apparatus 9 by the body-side discharge roller 71, a drive device (a contact/separation drive device) 82 which will be described later separates a first discharge roller 95A and a second discharge roller 95B of the post-processing-side discharge roller pair 95. That is, while the body-side discharge roller 71 is carrying the sheet P2, the first discharge roller 95A and the second discharge roller 95B of the post-processing-side discharge roller pair 95 do not interpose and carry the sheet P. Accordingly, the sheet P2 is not carried by the rollers having different rotation speeds, and thus it is possible to prevent a sheet jam.

The post-processing-side discharge roller pair 95 includes the first discharge roller 95A and the second discharge roller 95B, for example, where the first discharge roller 95A is a driving roller and the second discharge roller 95B is a driven roller.

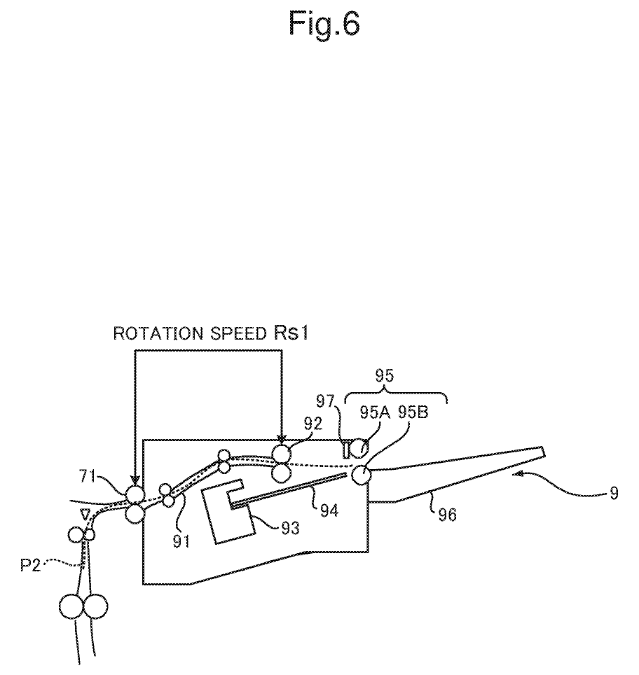

The post-processing apparatus 9 includes a detection device (a sheet detection device) 99 in the vicinity of the post-processing-side discharge roller pair 95. The sheet detection device 99 is, for example, an optical sensor such as a photo-interrupter including a light emitting element and a light receiving element. As illustrated in FIG. 6, when the sheet P2 reaches the post-processing-side discharge roller pair 95 and the detection device 99 detects the sheet P2, a detection signal is output to the control device 811 which will be described later at the detection time point. When the detection signal is received from the detection device 99, the control device 811 calculates a residual carrying time which is a time from a time point at which the detection signal has been received to a time point at which the body-side discharge roller 71 ends carrying of the sheet P2. The residual carrying time is calculated using a difference between the length in the sheet carrying direction of the sheet P2 and the carrying passage length of the carrying passage 91, the rotation speed Rs1 of the body-side discharge roller 71, and the like. Then, the control device 811 starts measuring time.

When the residual carrying time elapses, that is, when the body-side discharge roller 71 ends carrying of the sheet P2, the control device 811 brings the first discharge roller 95A and the second discharge roller 95B into contact using the drive device 82. In addition, the intermediate roller 92 and the post-processing-side discharge roller pair 95 are caused to rotate at the rotation speed Rs2.

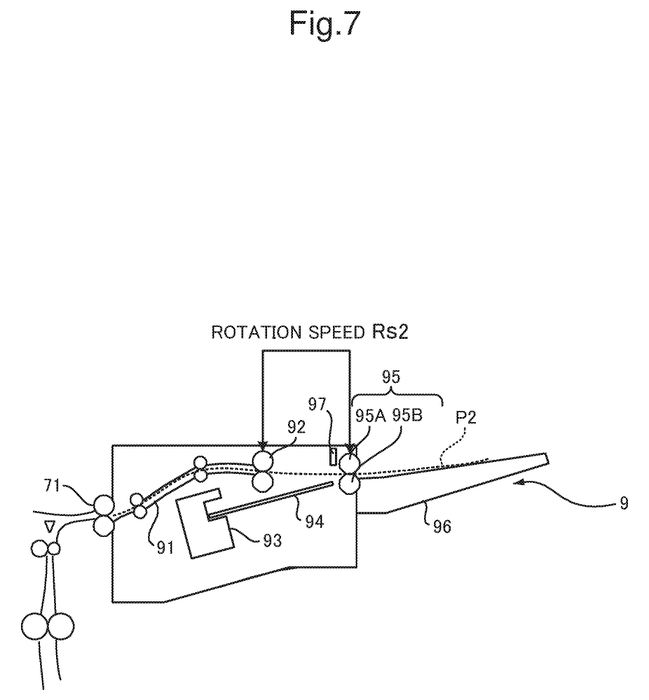

FIG. 7 is a diagram illustrating a state when the body-side discharge roller 71 has ended carrying of the sheet P2, the first discharge roller 95A and the second discharge roller 95B of the post-processing-side discharge roller pair 95 come into contact with each other, and the intermediate roller 92 and the post-processing-side discharge roller pair 95 rotate at the rotation speed Rs2 to carry the sheet P2 to the second discharge tray 96. Since the sheet P2 is carried by the intermediate roller 92 and the post-processing-side discharge roller pair 95 which rotate at the rotation speed Rs2 higher than the rotation speed Rs1, it is possible to increase a carrying speed and to improve productivity.

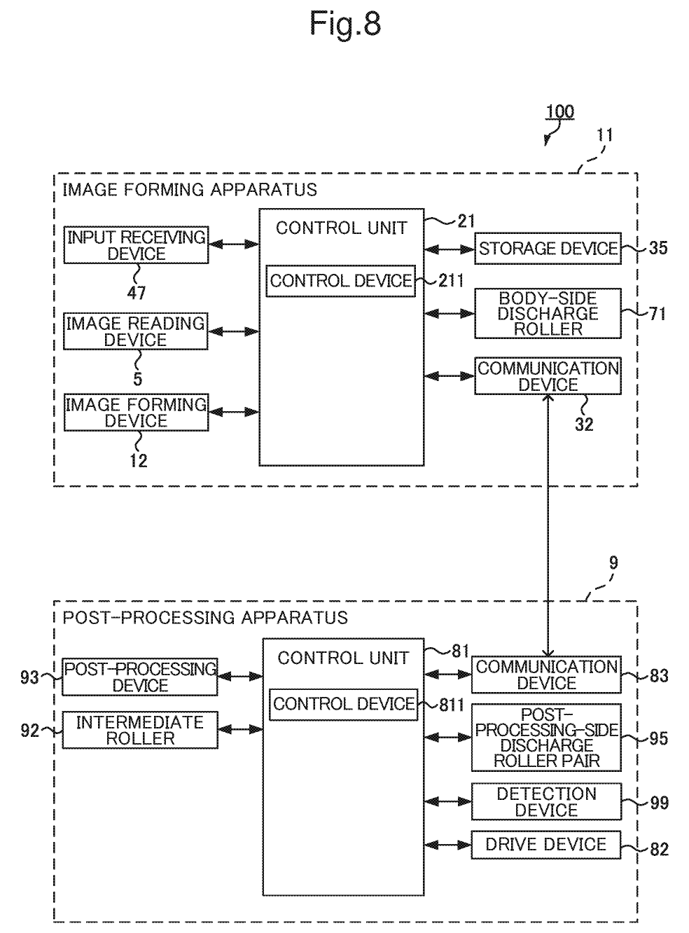

FIG. 8 is a block diagram illustrating an internal configuration of the image forming apparatus 100. The image forming apparatus 100 includes the apparatus body 11 and the post-processing apparatus 9. The apparatus body 11 includes a control unit 21, an image reading device 5, an image forming device 12, an input receiving device 47, a storage device 35, a body-side discharge roller 71, and a communication device 32. The same constituents as described above with reference to FIGS. 1 - 7 will be referred to by the same reference signs, and description thereof will be omitted.

The storage device 35 is a large-capacity storage device constituted by a solid state drive (SSD) or a hard disk drive (HDD) storing image data, various programs, data tables, and the like.

The communication device 32 is a communication module that exchanges various types of data such as transmitting print job information or information required for post-processing settings to the post-processing apparatus 9 and receiving necessary information such as a post-processing situation from a communication device 83 of the post-processing apparatus 9.

The control unit 21 includes a processor, a random access memory (RAM), and a read only memory (ROM). The processor is a central processing unit (CPU), a micro-processing unit (MPU), an application-specific integrated circuit (ASIC), or the like. The control unit 21 serves as a control device 211 by causing the processor to execute a control program stored in the ROM or the like. The control device 211 of the control unit 21 may be constituted by a hardware circuit regardless of operations based on the control program. The control device 211 takes charge of operation control of the image forming apparatus 100 as a whole.

The post-processing apparatus 9 includes a control unit 81, a post-processing device 93, an intermediate roller 92, a communication device 83, a post-processing-side discharge roller pair 95, a detection device 99, and a drive device 82.

The communication device 83 is a communication module that exchanges various types of data such as receiving print job information or information required for post-processing settings from the apparatus body 11 and transmitting necessary information such as a post-processing situation from the apparatus body 11.

The drive device 82 includes, for example, a mechanism for performing an operation of contacting or separating the first discharge roller 95A and the second discharge roller 95B, a drive source thereof, a solenoid attached to an axial support axially supporting a rotation shaft of the first discharge roller 95A or the second discharge roller 95B or an arm member attached to the axial support and operating with a driving power from the drive source, and the drive source (such as a motor). The drive device 82 contacts or separates two rollers, for example, by moving the first discharge roller 95A upward or downward.

The control unit 81 includes a processor, a RAM, and a ROM. The processor is a CPU, an MPU, an ASIC, or the like. The control unit 81 serves as a control device 811 by causing the processor to execute a control program stored in the ROM or the like. The control device 811 of the control unit 81 may be constituted by a hardware circuit regardless of operations based on the control program. The control device 811 takes charge of operation control of the post-processing apparatus 9 as a whole and additionally performs drive control of the intermediate roller 92, the post-processing-side discharge roller pair 95, and the drive device 82. The control device 811 is an example of a control device in the claims.

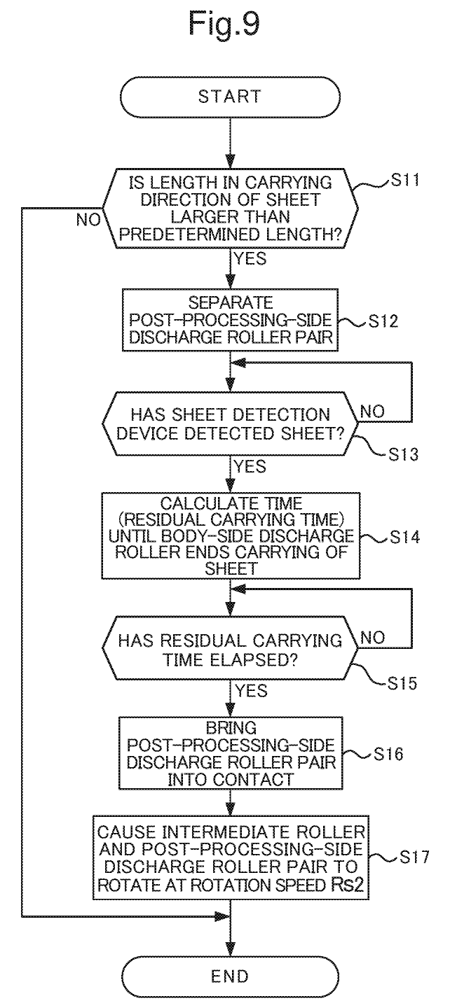

FIG. 9 is a flowchart illustrating a sheet carrying flow in the post-processing apparatus 9 according to the present embodiment. When a print job is performed and the length in the sheet carrying direction of a sheet carried to the post-processing apparatus 9 is larger than a predetermined length (S11: YES), the control device 211 of the apparatus body 11 transmits a signal indicating that a sheet longer than the predetermined length is carried to the post-processing apparatus 9 via the communication device 32.

Then, the control device 811 of the post-processing apparatus 9 performs control for separating the first discharge roller 95A and the second discharge roller 95B using the drive device 82 (S12). Accordingly, the first discharge roller 95A and the second discharge roller 95B are separated from each other. In the meantime, the control device 811 causes the intermediate roller 92 to rotate at the rotation speed Rs1. That is, the intermediate roller 92 rotates at the same rotation speed Rs1 as the body-side discharge roller 71.

When the detection device 99 detects a leading end of a sheet (S13), the control device 811 calculates a residual carrying time which is a time until the body-side discharge roller 71 ends carrying of the sheet and measures the residual carrying time (S14). When the residual carrying time elapses (S15: YES), the control device 811 performs control for bringing the first discharge roller 95A and the second discharge roller 95B into contact with each other using the drive device 82 (S16). The control device 811 performs control for causing the intermediate roller 92 and the post-processing-side discharge roller pair 95 to rotate at the rotation speed Rs2 higher than the rotation speed Rs1 (S17).

As described above, when the length in the sheet carrying direction of a sheet is larger than a predetermined length, the first discharge roller 95A and the second discharge roller 95B of the post-processing-side discharge roller pair 95 of the post-processing apparatus 9 are separated from each other, and the body-side discharge roller 71 and the intermediate roller 92 rotating at the same rotation speed Rs1 carry the sheet. When the body-side discharge roller 71 ends carrying of the sheet, the control device 811 brings the first discharge roller 95A and the second discharge roller 95B into contact with each other and causes the intermediate roller 92 and the post-processing-side discharge roller pair 95 to rotate at the rotation speed Rs2 to carry the sheet. Accordingly, even when the length in the sheet carrying direction of a sheet is larger than the predetermined length, the sheet is not suspended between rollers rotating at different rotation speeds, and it is possible to carry and discharge the sheet normally.

When a sheet printed by a general image forming apparatus is sent to the post-processing apparatus, the sheet is suspended between the discharge roller of the image forming apparatus and the intermediate roller of the post-processing apparatus, and thus the rotation speeds of these two rollers have to be the same. When the rotation speeds of the two rollers are different, a sheet jam, pulling of a sheet, or the like occurs.

When a sheet passes through the discharge roller of the image forming apparatus, the intermediate roller rotates at a higher rotation speed, the discharge roller discharging the post-processed sheet rotates at that rotation speed. Accordingly, it is possible to fast discharge the post-processed sheet and to enhance productivity.

However, when a length in a sheet carrying direction is larger than a general length, a sheet may be suspended between the discharge roller and the intermediate roller of the image forming apparatus and the discharge roller of the post-processing apparatus. When the rotation speeds of these three rollers are different, a sheet jam or pulling of a sheet occurs.

In the present embodiment, it is possible to prevent a sheet jam and to discharge a sheet from the post-processing apparatus normally.

The present disclosure is not limited to the configuration of the aforementioned embodiment and can be modified in various forms. For example, in the present embodiment, the post-processing apparatus 9 is an inner finisher which is attached to the first discharge tray 25 of the apparatus body 11, but may be a post-processing apparatus of a type which is disposed beside the apparatus body 11 or may be a post-processing apparatus with another configuration.

In the present embodiment, the post-processing apparatus 9 includes the post-processing device 93 that performs a stapling process, but may further include a device that performs a punching process for a punched hole or a sorting device. In this case, a length of the carrying passage 91 may change. Even when the length of the carrying passage 91 from the body-side discharge roller 71 to the post-processing-side discharge roller pair 95 which is the predetermined length changes by the device that performs a punching process for a punched hole or the sorting device, the length is measured at the time of apparatus design and is stored in advance by the control device 811 of the post-processing apparatus 9 which will be described later, and thus it is possible to cope with a case in which the length of the carrying passage 91 changes.

In the aforementioned embodiment, the configuration and the process described in the embodiment with reference to FIGS. 1 - 9 are merely an embodiment of the present disclosure, and it is not intended to limit the present disclosure to the configuration and the process. For example, in the aforementioned embodiment, the control device 811 of the post-processing apparatus 9 performs the process steps illustrated in FIG. 9, but the control device 211 of the apparatus body 11 may perform the process steps instead. When this modification is employed, the control device 211 receives signals required for performing the process steps from sensors or the like. In this case, the control device 211 of the apparatus body 11 is an example of the control device in the claims.

While the present disclosure has been described in detail with reference to the embodiments thereof, it would be apparent to those skilled in the art that the various changes and modifications may be made therein within the scope defined by the appended claims. It should be understood that the present disclosure is not limited to the exemplary embodiment described in this specification.

What is claimed is:

1. An image forming apparatus comprising:
an apparatus body including an image forming device configured to form an image on a sheet in accordance with a print job; and
a post-processing apparatus including a post-processing device attached to the apparatus body and configured to perform post-processing on the sheet in accordance with the print job,
wherein the apparatus body further includes a body-side discharge roller that carries the sheet on which an image has been formed by the image forming device from an apparatus-side discharge port to the post-processing apparatus,
wherein the post-processing apparatus further includes:
a carrying passage along which a sheet is carried from an input port receiving a sheet carried by the body-side discharge roller to a discharge port;
an intermediate roller that rotates at a first rotation speed which is the same rotation speed as the body-side discharge roller or a second rotation speed higher than the first rotation speed and carries a sheet to the post-processing device or the discharge port;
a post-processing-side discharge roller pair that includes a first discharge roller and a second discharge roller, is disposed upstream from the discharge port in a sheet carrying direction and downstream from the intermediate roller, and rotates at the second rotation speed to discharge a sheet carried by the intermediate roller to the discharge port;
a detection device that detects that a sheet leading end in the sheet carrying direction of the sheet has reached the post-processing-side discharge roller pair;
a drive device that moves the first discharge roller and the second discharge roller to a contact position or a separation position; and
a control unit that includes a processor and serves as a control device configured to perform drive control of the intermediate roller, the post-processing-side discharge roller pair, and the drive device by causing the processor to execute a control program,
wherein the control device causes the intermediate roller to rotate at the first rotation speed and separates the first discharge roller and the second discharge roller from each other using the drive device in a period in which the body-side discharge roller is carrying a sheet when a length in the sheet carrying direction of the sheet is larger than a predetermined length, and
wherein the control device calculates a residual carrying time which is a time from a detection time point at which the detection device detects a sheet leading end of a sheet to a time point at which the body-side discharge roller ends carrying of the sheet, brings the first discharge roller and the second discharge roller into contact using the drive device when the residual carrying time elapses, and causes the intermediate roller and the post-processing-side discharge roller pair to rotate at the second rotation speed.

2. The image forming apparatus according to claim 1, wherein an inner sheet discharge part in which a sheet on which an image has been formed by the image forming device is able to be accommodated is formed in an open space in the apparatus body, and
wherein the post-processing apparatus is installed in the inner sheet discharge part.

3. The image forming apparatus according to claim 1, wherein the predetermined length is a length of the carrying passage from the body-side discharge roller to the post-processing-side discharge roller pair.

4. The image forming apparatus according to claim 1, wherein the post-processing device performs a stapling process as the post-processing.
